(19) United States
(12) Patent Application Publication
(10) Pub. No.: US 2010/0055945 A1
(43) Pub. Date: Mar. 4, 2010

(54) ELECTRICAL CONTACT

(75) Inventors: GAO-BING LEI, Shenzhen (CN); NAN HU, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/512,312

(22) Filed: Jul. 30, 2009

(30) Foreign Application Priority Data
Sep. 4, 2008 (CN) 200820185405.7

(51) Int. Cl. H01R 12/00

(52) U.S. Cl. 439/81

(57) ABSTRACT

A contact used in an electrical connector for mounting onto a PCB includes: a base portion with a horizontal bottom surface and at least one locking hole formed on the bottom surface, a spring beam bended from one end of the base portion and extending upwardly to contact with a mating object, and at least one soldering pad received in the locking hole correspondingly. The soldering pad includes a pair of soldering legs with soldering surfaces thereon for soldering onto the PCB. The soldering material on the soldering surfaces of the soldering pads is not easy to creep upwardly onto the spring beam so that the spring beam can keep a good performance during a mating process with a mating object.

### BACKGROUND OF THE INVENTION

1. Field of the invention

The present invention relates to an electrical contact used in an electrical connection which is mounted on a PCB (printed circuit board) and electrically contacts with a mating object.

2. Description of Related Art

Nowadays, an electrical contact has a soldering portion mounted on a PCB by SMT (Surface Mount Technology) and a spring beam extending curvedly and contacting with the mating object electrically. The liquid soldering material on the soldering surface may probably creep up onto a curved portion between the solder portion and the spring beam, which increases the thickness of the curved portion. During the contacting process with the object, the curved portion of the contact will be curved and provide an elasticity for the contact. Obviously, the increasing thickness of the curved portion will reduce the elasticity of the contact, sometimes may also lead to a permanent distortion or a crack for the curved portion.

So it is necessary to provide a new type contact to solve the problems above.

### SUMMARY OF THE INVENTION

Accordingly, it is an object of the present invention to provide a new type contact which can stop the creeping of the soldering material.

In order to achieve above-mentioned object, a contact for being soldered on a PCB is provided and comprises: a base portion with a horizontal bottom surface and at least one locking hole formed on the bottom surface, a spring beam bended from one end of said base portion and extending upwardly to contact with a mating object, and at least one soldering pad received in said locking hole correspondingly. The soldering pad includes a pair of soldering legs with soldering surfaces thereon for soldering onto the PCB.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of the contact in accordance with the present invention;

FIG. 2 is a perspective view of the contact of FIG. 1 from another view; and

FIG. 3 is an exploded perspective view of the contact of FIG. 1.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

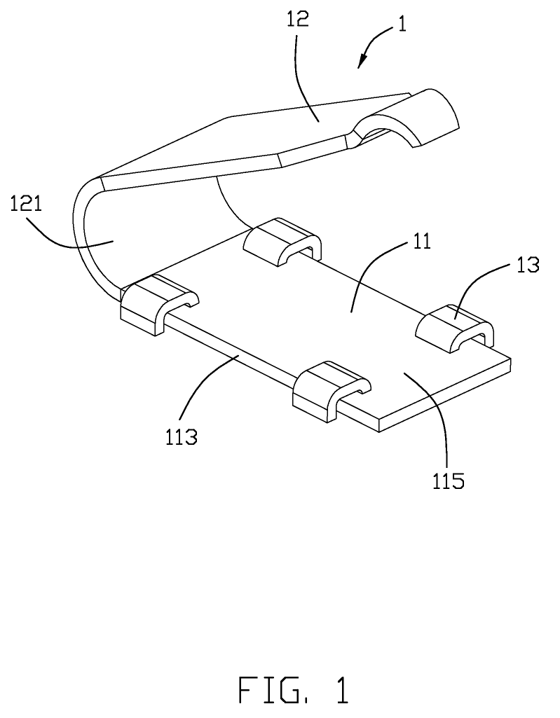

Referring to FIGS. 1 to 3, a contact 1 is made of a metal piece and includes a horizontal rectangular base portion 11, a spring beam 12 bended from one end of the base portion 11 and extending upwardly along an inclined direction, and a plurality of soldering pads 13 assembled on two sides of said base portion 11 for being soldered on a PCB.

The base portion 11 extends longitudinally and defines a first end 111 and a second end 112, a first side edge 113 and a second side edge 114, a bottom surface 116 for being mounted on the PCB, and a upper surface 115 reverse to the bottom surface 116. The spring beam 12 extends from said first end 111 of the base portion 11 and includes an arc portion 121 bended from the first end 111, an connecting portion 122 extending upwardly from said arc portion 121 along the inclined direction and a distal end 123 protruding from the connecting portion 122 for contacting with a mating object.

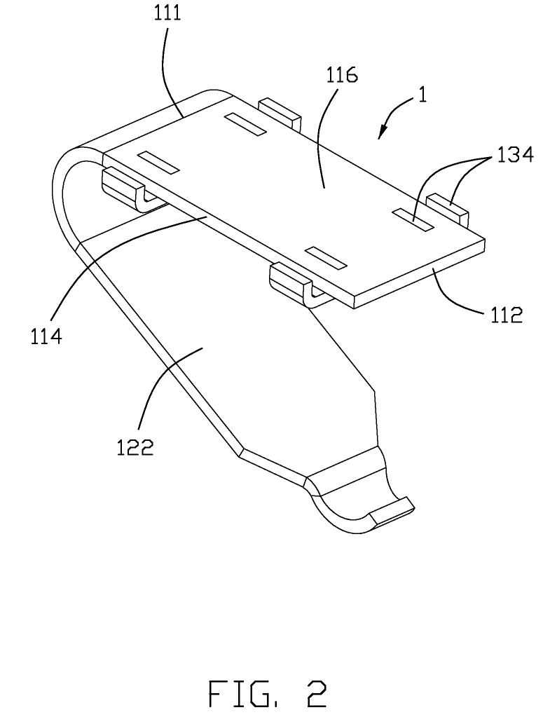

As referring to FIG. 2, said base portion 11 has a plurality of locking holes 117 formed along the first side 113 and the second side 114. Said soldering pads 13 is reverse U-shaped and retained into said locking holes 117. Each soldering pad 13 includes a first soldering leg 131 received in said locking holes 117, a second soldering leg 132 located by an outer side of the base portion 11 opposite to said first soldering leg 131, and a bridge portion 133 connecting with said first and second soldering leg 131, 132. Said first and second soldering leg 131, 132 has a soldering surface 134 which is coplanar with said bottom surface 116 of the base portion 11.

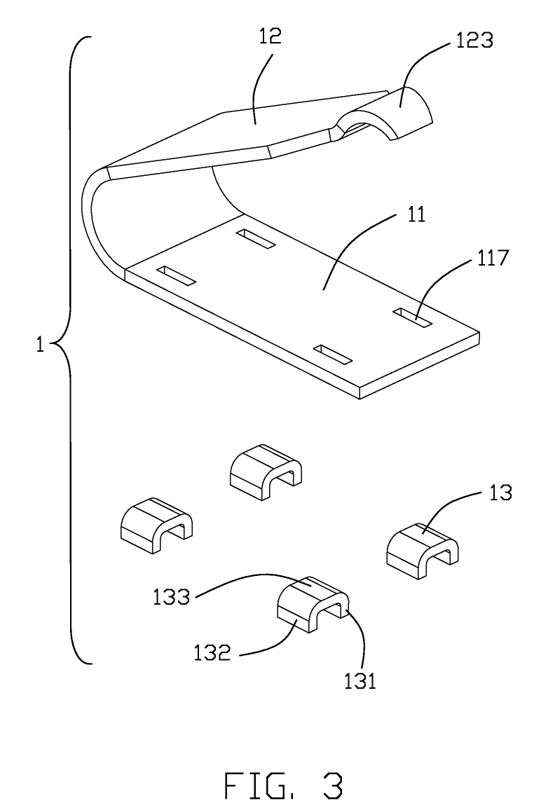

In FIGS. 2 and 3, the soldering pads 13 are mounted on the PCB to get a stable connection between the contact 1 and the PCB. Said soldering surfaces 134 of the soldering pads 13 are dispersedly located around the base portion 11 in order to be soldered with the soldering material on the PCB. The contact 1 is connected stably on the PCB only in a way of soldering the soldering pads 13 onto the PCB, and the bottom surface 116 of the base portion 11 is not used to be soldered with the soldering material directly, which can reduce the probability for the liquid soldering material creeping upwardly onto the arc portion 121. Besides, the second soldering legs 132 are located by an outer side of said base portion 11 so as to improve the retaining force between the base portion 11 and the PCB. Moreover, said first and second soldering legs 131, 132 of the soldering pads 13 can be mounted onto the PCB by Though-hole Technology as well, instead of SMT.

However, while the preferred embodiment of the invention have been shown and described, it will apparent to those skilled in the art that changes and modifications may be made therein without departing from the spirit of the invention, the scope of which is defined by the appended claims.

What is claimed is:

1. A contact for being soldered on a PCB comprising:
a base portion with a horizontal bottom surface and at least one locking hole formed on the bottom surface;
a spring beam bended from one end of said base portion and extending upwardly to contact with a mating object;
at least one soldering pad received in said locking hole correspondingly and including a pair of soldering legs with soldering surfaces thereon for soldering onto the PCB.

2. The contact as claimed in claim 1, wherein said soldering pad is assembled onto the base portion with one soldering leg retained in the locking hole and another soldering leg located on an outer side of the base portion.

3. The contact as claimed in claim 1, wherein said base portion is rectangular shaped and defines a first side edge and a second side edge, said locking holes are located along the first and second side edge.

4. The contact as claimed in claim 2, wherein the base portion further defines a first end and a second end, the spring beam extends from the first end of the base portion upwardly along an inclined direction.

5. The contact as claimed in claim 4, wherein each soldering pad further includes a bridge portion connecting with said pair of soldering legs to defines a reverse U-shaped structure.

6. The contact as claimed in claim 1, wherein said soldering leg of the soldering pad has a soldering surface which is coplanar with said bottom surface of the base portion.

7. The contact as claimed in claim 6, wherein the spring beam includes an arc portion connecting with the base portion, a connecting portion extending from the arc portion upwardly and a distal end protruding from the connecting portion.

8. The contact as claimed in claim 7, wherein one soldering leg of each soldering pad is located on an outer side of the base portion, while another soldering leg is retained in the locking hole of the base portion.

9. An electrical contact comprising:
a planar base for confrontation with a printed circuit board;
a spring arm unitarily extending upwardly from the base; and
at least a solder pad being discrete from the base and attached to an edge region of the base; wherein
said solder pad defines an outer leg spaced from an edge of said edge region for soldering to the printed circuit board, and an inner leg retained to the base.

10. The electrical contact as claimed in claim 9, wherein said inner leg and said outer leg are linked with each other via a bight crossing and downwardly facing said edge.

11. The electrical contact as claimed in claim 10, wherein said bight is seated upon the edge region.
